(19) United States
(12) Patent Application Publication
(10) Pub. No.: US 2005/0168344 A1
(43) Pub. Date: Aug. 4, 2005

(54) Seat-based weight sensor

(76) Inventor: Matthew G. Bevan, Silver Spring, MD (US)

Correspondence Address: Benjamin Y Roca;The Johns Hopkins University, Applied Physics Lab Mail Stop 7 156, 11100 Johns Hopkins Road, Laurel, MD, 20723-6099, US

(21) Appl. No.: 10/487,059

(22) PCT Filed: Jul. 30, 2003
(86) PCT No.: PCT/US03/24076

Related U.S. Application Data
(60) Provisional application No. 60/400,120, filed on Aug. 1, 2002.

(51) Int. Cl. G08B 21/00

(52) U.S. Cl. 340/667; 324/207.11

(57) ABSTRACT

An apparatus and method for measuring the weight of an occupant of a seat is described. The weight of the occupant can be determined by measuring the deflection of a portion of the seat. This may be accomplished through the use of a magnet and Hall-effect sensor, wherein deflection of a portion of the seat may cause a change in the distance between the magnet and the Hall-effect sensor. This change in distance may result in a change in intensity measured by the sensor, which can then be correlated to the weight of the occupant. Particular application may be made to measuring the weight of an occupant of an automobile, for purposes such as safety and ergonomics, and more readily to assist in the development of improved airbag deployment strategies.

### CROSS-REFERENCE TO RELATED APPLICATIONS

This application claims benefit of U.S. Provisional Application Ser. No. 60/400,120, filed Aug. 1, 2002, the entire contents of which are hereby incorporated by reference.

### BACKGROUND OF THE INVENTION

1. Field of the Invention

The present invention relates to an apparatus and method for measuring the weight of an occupant of a seat. More specifically, it relates to measuring the weight of an occupant of a seat through the use of a magnet and a linear Hall-effect sensor.

2. Description of the Related Art

There are a number of uses for knowing the weight of an occupant of a seat, and further, the weight of an occupant of a car seat. These may fall into several categories: safety, ergonomics, among others. Knowledge of the occupant's weight can also contribute to both improved functionality of safety systems and more user-friendly positioning of the occupants among other uses.

An active area of engineering research and development involves developing low-risk airbag deployment strategies. It is acknowledged that many airbag deployments are inappropriate to the situation. For example, in many cases the airbag system deploys the passenger seat airbag when the passenger seat is unoccupied, leading to unnecessary airbag reinstallation costs for the user and/or the insurance company. Perhaps more importantly, injury can occur to an occupant due to an amount of extra energy in the airbag deployment. One area of ongoing research involves developing a control module which is capable of tailoring various aspects of the airbag deployment to the specific occupant of the seat. An important input to such a control module is the weight of the occupant which is a variable discussed in the present invention.

Conventional systems may rely on pressure sensors and strain gages to measure loads. While pressure sensors and strain gages vary in design, each having its own advantages, disadvantages and specific utilities, they can suffer from a number of general drawbacks. For example, some desirable strain gage materials are also sensitive to temperature variations. Therefore, they may require a temperature-compensation technique to be added to the system. Also, strain gages tend to change resistance as they age, requiring adjustment and/or replacement. For the case of semiconductor strain gages, the resistance-to-strain relationship is likely nonlinear, requiring software compensation to overcome nonlinearity.

Therefore, what is needed is an apparatus and method for measuring the weight of an occupant of a car seat, having a linear response, and which is robust with respect to variations in ambient conditions and aging of the materials, thus addressing and solving problems associated with conventional systems.

### SUMMARY OF THE INVENTION

It is an object of the invention disclosed herein to provide a method and apparatus for measuring the weight of an occupant of a car seat, which uses a magnet and linear Hall-effect sensor.

The invention can determine the weight of the occupant by measuring the deflection of certain portions, e.g, in one embodiment, the bottom surface, of the seat. In one embodiment, the deflection of the bottom surface of a car seat is measured as follows. A magnet is mounted to the springs on the bottom of the seat. Opposing the magnet is a linear Hall-effect sensor. As the seat bottom deflects, the magnet moves closer to the Hall-effect sensor. This increases the intensity of the magnetic field at the Hall-effect sensor, causing the sensor to change its response. This change in response is measured and correlated with the weight of the occupant of the car seat. Clearly, the design may be modified so that upon deflection of the seat, the magnet moves farther from the Hall-effect sensor, and the consequent change in response (a decrease in this case) is correlated with the weight of the occupant.

An advantage of this embodiment is its use of established technology for a novel purpose. There is no electronics development needed, and the technique benefits from the many advantages of linear Hall-effect sensors. For instance, linear Hall-effect sensors may enjoy relative insensitivity to certain ambient conditions, e.g. they can be stable with respect to changes in temperature, humidity, vibration and dust. They also have many properties which are constant over time, whereas many other sensor types degrade much more rapidly with age. Furthermore, since they lack mechanical contacts, Hall effect sensors are more robust than other sensors whose contacts wear and can become an interference source due to arcing. Moreover, since Hall-effect sensors are based on semiconductors, carrier mobility can be controlled by adding impurities, thus making it possible to obtain a repeatable Hall coefficient.

### BRIEF DESCRIPTION OF THE DRAWINGS

The teachings of the present invention can be readily understood by considering the following detailed description in conjunction with the accompanying drawings, in which:

FIG. 1 depicts one embodiment of the invention using one magnet and linear Hall-effect sensor.

FIG. 2 depicts a second embodiment of the invention using two magnets and linear Hall-effect sensors.

FIG. 3 depicts a third embodiment of the invention wherein the magnet and sensor can move apart with increasing occupant weight.

FIG. 4 depicts a fourth embodiment wherein the magnet and linear Hall-effect sensor are installed on the four seat mounting posts to measure the forces transmitted through the posts by the occupant's weight.

### DETAILED DESCRIPTION OF EXEMPLARY EMBODIMENTS

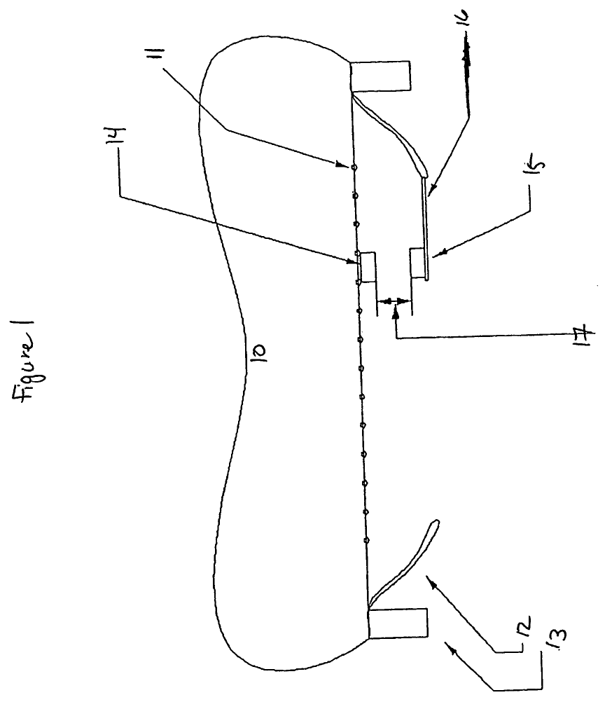

FIG. 1 depicts an embodiment of the invention using one magnet 14 and linear Hall-effect sensor 15. The seat, in this case, consists of existing foam 10, springs 11, seat pan 12 and rail 13. With such a seat configuration, a permanent magnet 14 may be mounted to the springs on the bottom of the seat. The Hall effect sensor 15 is mounted to a flexible support arm 16 which is attached to the seat pan 12. As the seat bottom deflects, the magnet moves closer to the Hall-effect sensor. This increases the intensity of the magnetic field at the Hall sensor, causing the sensor to change its response. This change in response is measured and correlated with the weight of the occupant. Note that the gap 17 between the permanent magnet 14 and the Hall effect sensor 15 may be adjusted in design for sensitivity range. In this embodiment, the sensor may be mounted on the side, front or back of the seat pan.

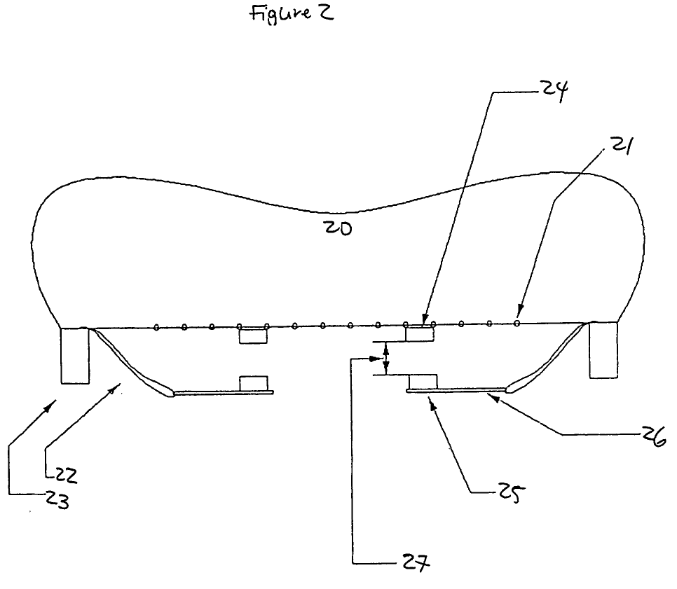

FIG. 2 depicts a second embodiment of the invention using two sets of magnets and sensors. This embodiment is similar to that shown in FIG. 1, with the seat consisting of existing foam 20, springs 21, seat pan 22 and rail 23. With such a seat configuration, a permanent magnet 24 may be mounted to the springs on the bottom of the seat. The linear Hall effect sensor 25 is mounted to a flexible support arm 26 which is attached to the seat pan 22, wherein as the seat bottom deflects, the magnets move closer to the Hall-effect sensor, thereby increasing the intensity of the magnetic field and changing the response of the sensor. Note that the gap 27 between the permanent magnet 24 and the Hall effect sensor 25 may be adjusted in design for sensitivity range.

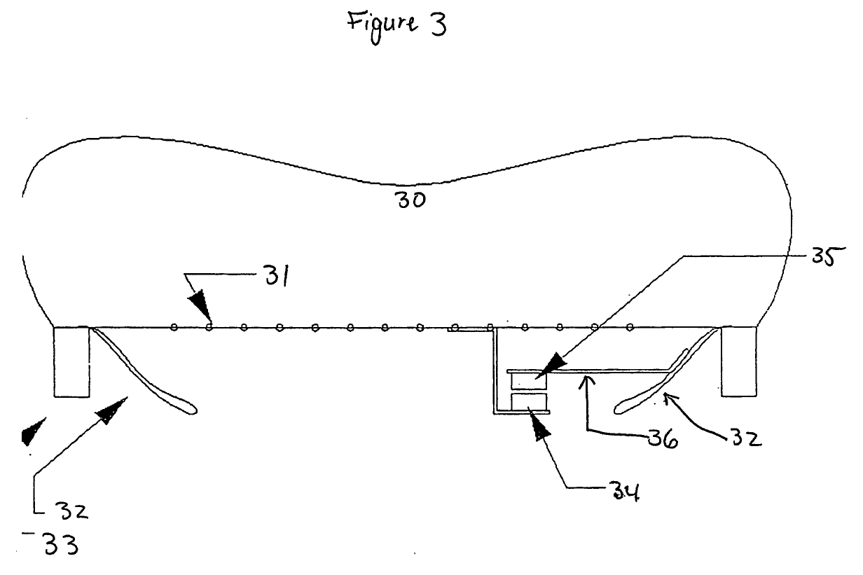

FIG. 3 depicts a third embodiment of the invention wherein as the seat bottom deflects, the magnet moves away from the sensor. The seat consists of existing foam 30, springs 31, seat pan 32 and rail 33. With such a seat configuration, a permanent magnet 34 may be mounted to the springs on the bottom of the seat. The linear Hall effect sensor 35 is mounted to a flexible support arm 36 which is attached to the seat pan 32. In such an embodiment, as the seat bottom deflects, the intensity of the magnetic field decreases, and the response of the sensor changes accordingly.

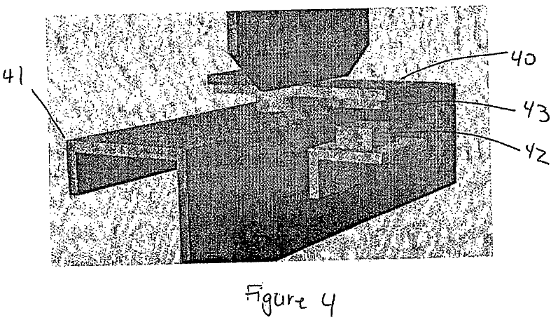

FIG. 4 depicts a fourth embodiment of the invention wherein the magnet and linear Hall-effect sensor can be installed on the four seat mounting posts to measure the forces transmitted through the posts. The Hall-effect sensor 42 is mounted to the seat track 41 and the magnet 43 is mounted to the seat post 40. As the load in the seat increases, the gap between the magnet and the Hall-effect sensor decreases. As in FIG. 3, this embodiment may also be configured to move the magnet away from the Hall-effect sensor as the load increases.

Although specific embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

1. An apparatus for measuring an occupant's weight, comprising:
an occupant support, having a first portion and a second portion, wherein the first portion is deflected due to the occupant's weight and the second portion is not deflected due to the occupant's weight;
a magnet mounted to the first portion; and
a linear Hall-effect sensor attached to the second portion, wherein the magnet opposes the linear Hall-effect sensor.

2. The apparatus as in claim 1, wherein the first portion comprises a spring, and the second portion comprises a seat pan.

3. The apparatus as in claim 1, wherein the first portion comprises seat posts, and the second portion comprises a seat track.

4. An apparatus for measuring an occupant's weight, comprising:
an occupant support, having a first portion and a second portion, wherein the first portion is deflected due to the occupant's weight and the second portion is not deflected due to the occupant's weight;
a linear Hall-effect sensor mounted to the first portion;
a magnet attached to the second portion, wherein the magnet opposes the linear Hall-effect sensor.

5. The apparatus as in claim 4, wherein the first portion comprises a spring, and the second portion comprises a seat pan.

6. The apparatus as in claim 4, wherein the first portion comprises a seat post, and the second portion comprises a seat track.

7. A method for measuring the weight of an occupant of a seat, comprising:
providing an occupant support, having a first portion and a second portion, wherein the first portion is deflected due to the occupant's weight and the second portion is not deflected due to the occupant's weight;
mounting a magnet to the first portion; and
attaching a linear Hall-effect sensor to the second portion, wherein the magnet opposes the linear Hall-effect sensor.

8. The method of claim 7, wherein the first portion comprises a spring, and the second portion comprises a seat pan.

9. The method of claim 7, wherein the first portion comprises seat posts, and the second portion comprises a seat track.

10. A method for measuring the weight of an occupant of a seat, comprising:
providing an occupant support, having a first portion and a second portion, wherein the first portion is deflected due to the occupant's weight and the second portion is not deflected due to the occupant's weight;
mounting a linear Hall-effect sensor to the first portion;
attaching a magnet to the second portion, wherein the magnet opposes the linear Hall-effect sensor.

11. The method of claim 10, wherein the first portion comprises a spring, and the second portion comprises a seat pan.

12. The method of claim 10, wherein the first portion comprises a seat post, and the second portion comprises a seat track.
